(19) United States
(12) Patent Application Publication
(10) Pub. No.: US 2012/0178540 A1
(43) Pub. Date: Jul. 12, 2012

(54) Elastic Coupling

(75) Inventors: Markus K. Becker, Aachen (DE); Maik Marcinkowski, Bochum (DE)

(73) Assignee: Voith Patent GMBH, Heidenheim (DE)

(21) Appl. No.: 13/382,337

(22) PCT Filed: Jun. 23, 2010
(86) PCT No.: PCT/EP10/03832

§ 371 Date: Mar. 21, 2012

(30) Foreign Application Priority Data
Jul. 9, 2009 (DE) 102009032690.1

(51) Int. Cl. F16D 3/68

(52) U.S. Cl. 464/85

(57) ABSTRACT

An elastic coupling comprises a primary part (2) and a secondary part (3). Furthermore, a plurality of spring elements (4) is distributed around the circumference between the primary part (2) and the secondary part (3). The spring elements (4) comprise at least one elastic spring body (6), which is arranged between two support plates (5). The elastic spring body (6) comprises a circumferential groove (7) at the end faces. In the biased state of the spring elements (4), the course of the contour of the groove (7) does not have an inflection point in a plane in which a center axis (A) of the elastic spring body (6) extends.

The invention relates to an elastic coupling with the features in the generic part of claim 1.

A generic coupling is described in the German printed patent specification DE 39 06 201 C2, for example. The torsionally flexible coupling described there comprises a primary part and a secondary part, which are essentially developed star-shaped here. For this purpose, spring elements are evenly distributed around the circumference between the primary part and the secondary part. The individual spring elements consist of elastic bodies, such as of rubber, with support plates arranged in between. The elastic bodies of rubber can be vulcanized onto the support plates.

If a load with a torque is now applied onto the elastic coupling, then the spring elements in the area of the elastic coupling will typically be squashed. The spring elements will moreover frequently be installed between the coupling parts in a biased state, so that squashing occurs already even in the unbiased state of the coupling. The groove-like contour extending around the elastic spring body which arches around the spring body in the unbiased state like a sector of a circle and/or a U, will be correspondingly biased for that purpose. Practice has now shown that the contour of this groove assumes a wavelike shape in the biased state, which is essentially developed like a rounded W. For this purpose, this contour with three inflection points has the decisive disadvantage that is accompanied by a comparatively high mechanical loading of the elastic spring body.

Thus practice has shown that such elastic couplings and/or their spring elements are very frequently damaged through the tearing of the elastic spring bodies, particularly in the area of the lowest points which lie furthest in the direction of the center point of the elastic spring bodies in the biased state of the W-shaped contour.

In order to prevent such damage from occurring and/or to delay it for as long as possible with respect to the service life of the spring elements, the spring elements are implemented with a comparatively large cross-section. This has the disadvantage, however, that the elastic coupling, particularly in the axial direction in the area of the spring elements becomes correspondingly thick, which requires much installation space. With the very compact drivetrains that have meanwhile become the standard, such as used in passenger cars but also increasingly in utility vehicles, this is a decisive disadvantage.

Based upon this problem, the invention presented here now has the purpose to indicate a structural design for an elastic coupling which avoids these disadvantages and which can present an elastic coupling which operates permanently reliable and in which the spring elements have a small cross-section.

The invention teaches that this objective is solved by the features in the characterizing part of claim 1. Advantageous developments and refinements of the structural design according to the invention can be found in the sub-claims.

By the fact that the course of the contour is developed so that it does not have an inflection point when the spring body is in its biased state, this results in a very much lower loading of the material of the elastic spring body. Experiments have shown that with comparable transferred torques and similar service life periods as they can be achieved with traditional elastic spring bodies according to the prior art, one third of the installation space of the spring elements can be saved. This saving in installation space can be especially accomplished in the axial dimensional design of the elastic coupling, so that a very narrow elastic coupling is created which can be integrated very much easier into existing spaces in a drivetrain than a conventional coupling. This structural design also has decisive advantages with respect to a much reduced structural space requirement with a comparable service life, or with a comparable structural space requirement, a very much longer service life of the spring bodies in the elastic coupling.

This course of the contour without an inflection point which is accomplished in the biased state can be accomplished in an especially preferred type in that the contour in its unbiased state runs axisymmetrical to a centerline in a plane in which the central axis of the elastic spring body is developed, wherein each of the halves of the contour, based upon a zero gradient in the area of the centerline, runs with an increasing gradient. This course which is based on a zero gradient, i.e. on a tangent that runs parallel to the central axis of the elastic spring body on the contour which is facing the central axis at a point farthest away and starting from here has an increasing gradient up to the end of the respective contour, makes it possible that in the biased state of such elastic spring element, a contour without an inflection point can then be accomplished, which makes a very much higher stability and/or service life possible.

In a particularly advantageous and favorable refinement of the elastic coupling as taught by the invention it is further provided that the contour in the non-biased state is developed axisymmetrically to a centerline in a plane in which the central axis of the elastic solid body is formed, wherein the contour is limited by a set of multiple straights in direction of the central axis, wherein a first straight starting from the center line in a first angle of 40-50°, in particular 45°, extends to an auxiliary straight arranged perpendicular to the centerline; and each further straight on the antecedent straight starts in a point in which the projection of the antecedent straight at a point in which the projection of the antecedent straight perpendicular to the centerline reaches 40-60%, in particular 50%, of the remaining residual widths of the half of the contour, wherein the angle between the straight and the previous straight amounts to 40-60%, in particular 50% of the angle between the antecedent (auxiliary) straight.

This structural design, in which the continuous course of the curve of the contour adapts to a set of straights, which is respectively continued in the half of the remaining residual widths with a further straight, which runs approximately in the area of the angle bisector, results in a contour which is known as such from the field of bionics. In this context, such contour is considered as very favorable with respect to a potentially occurring notch effect The inventors have now surprisingly found that an embodiment of the groove in the elastic spring body in the unbiased state pursuant to such regularity results also in a biased state in a contour which does not have an inflection point and represents an ideal embodiment with respect to the occurring notch effects. Such contour modeled in the unbiased state can also enable optimal strength of the elastic spring body with the required and/or specified elasticity in the biased state. This structural design can consequently accomplish the desired mechanical properties with significantly smaller dimensions than it would be possible with assemblies pursuant to the prior art.

In a further, very favorable and advantageous refinement of the invention it is further provided that the contour in the biased state of the elastic spring body in each of the planes, in which the central axis of the elastic spring body extends, is essentially identical.

This means that the contour has the corresponding contour not only in certain areas of the elastic spring body, for example along its axial end faces with a rectangular spring body that has the corresponding contour, but circumferentially around the entire elastic spring body. In this way, a particularly good and uniform elasticity with optimum mechanical resistance of the elastic spring body can be accomplished.

In an advantageous embodiment of the elastic coupling it is provided moreover that the width of the contour occupies 85%-95%, preferably 93.5%, of the thickness of the elastic spring body, wherein on both sides of the contour, parts of the elastic spring body remain between the contour and the support plates, the outer contour of which essentially extends perpendicular to the center line. According to the normal structural design of the prior art, the elastic spring body is vulcanized onto the support plates and has a thickness in the area of the support plate and/or in the area of the conterminous edge of the support plate, which makes vulcanization possible. The structural design as taught by the invention provides however, that in this case a corresponding material thickness with 1-(85% to 95%), preferably 1-93.5% of the thickness of the elastic spring body is conterminous in the area of the support plate. For this purpose, this material thickness extends essentially so that the contour of the support plate is continued through the material thickness prior to where the groove with its contour starts. This edge region which is located in the range of 1-93.5% of the total thickness of the elastic spring body, which edge region splits up to the two support plates adjacent to the elastic spring body, also increases the mechanical strength of the elastic spring body, since the start of the contour does not begin directly or almost next to the support plates, but at a defined location within the elastic spring body itself. This makes it possible that in the area in which the groove discontinues, only the material of the elastic spring body is involved and in the event of any forces occurring in the radial direction, the connection between the elastic spring body and the support plate will not be subjected to shear by such forces. In a further very advantageous embodiment of the elastic coupling according to the invention it is moreover provided that the surfaces of the elastic spring bodies and the support plates that are developed vertical to the central axis are developed essentially reciprocally parallel in each of the elastic spring bodies and in each of the support plates.

Contrary to the also normal structural design of such elastic couplings, in which the support plates and/or elastic spring bodies are developed wedge-shaped in order to realize a spring element in this way which does not have a straight central axis but a central axis which follows the periphery of the elastic coupling, the parallel structural design of the elastic coupling as taught by the invention has corresponding advantages.

With a wedge-shaped structural design of either the support plates and/or the elastic spring bodies, it can very easily occur that the spring bodies and/or the support plates are squeezed out in an axial direction. With a structural design of the spring element which has a straight central axis and is essentially defined by parallel edge surfaces of the individual elastic spring bodies and support plates, any compressive force that occurs, as it acts during the transfer of a torque to the spring element, is uniformly distributed across the entire surface of the individual elastic support bodies and none or no significant force components occur in the radial direction of the elastic coupling. This also supports a better stability of the spring elements and thus makes it possible to build a smaller elastic coupling with a correspondingly longer service life.

Further advantageous developments of the elastic coupling as taught by the invention moreover results from the remaining dependent Claims and will become clear by means of the embodiment which will be explained in detail subsequently with reference to the Figures, as follows:

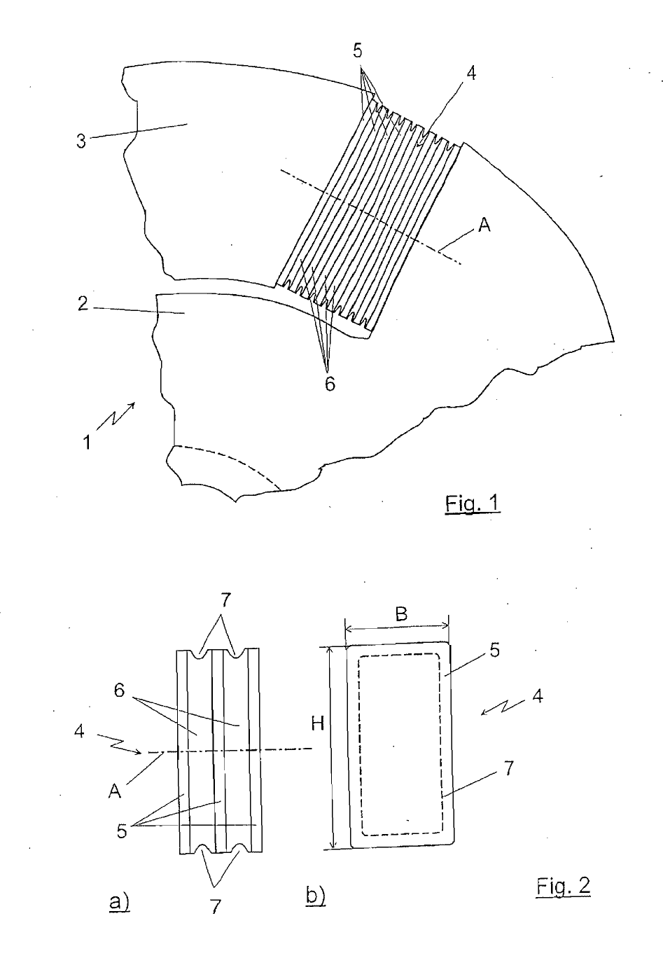

FIG. 1: shows a section of an elastic coupling as taught by the invention;

FIG. 2: shows a side elevation and a horizontal projection onto a part of a spring element, pursuant to FIG. 1;

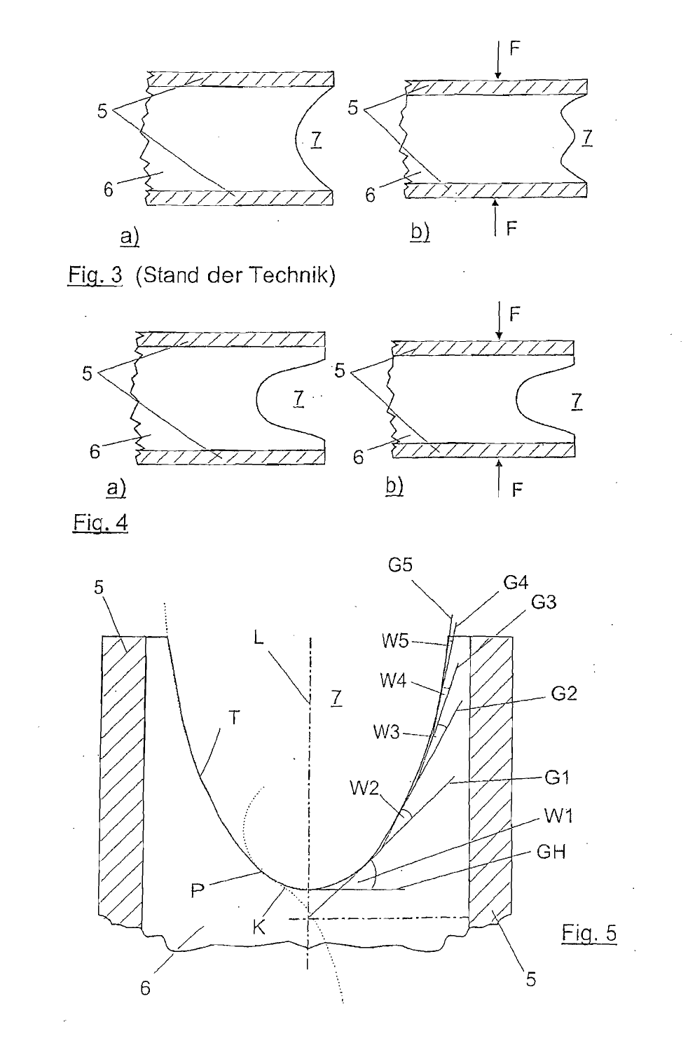

FIG. 3: shows a section from an elastic spring body with support plates according to the prior art in an unbiased and in a biased state;

FIG. 4: shows a section from an elastic spring body with support plates according to the invention in an unbiased and in a biased state; and

FIG. 5: shows a schematic representation regarding the structure of two exemplary contours of the elastic spring body as taught by the invention.

In the representation of FIG. 1, a section of an elastic coupling 1 can be seen which is configured as elastic or a highly flexible coupling which can be used in drivetrains, for example. Such drivetrains can be arranged particularly in vehicles, but also in industrial applications. The elastic coupling I consists essentially of a primary part 2 and a secondary part 3. In this context, the primary part 2 of the elastic coupling 1 is connected with the input side of a drivetrain in the usual known manner. The secondary part 3 is connected with the output side of the drivetrain. The elastic coupling 1 can be arranged between the engine and a transmission of the drivetrain. The primary part 2 would then be connected with the crankshaft and the secondary part 3 with the transmission inlet.

The primary part 2 and the secondary part 3 are reciprocally rotatable and have a star-shaped contour, for example. Between the elements which project radially to the outside of this star-shaped contour of the primary part 2 and the secondary part 3, spring elements 4 are arranged. For this purpose, an elastic coupling 1 typically has several of such spring elements 4, which are arranged between the primary part 2 and the secondary part 3 distributed around the circumference in the elastic coupling 1.

The elastic coupling 1 now functions in the actually known manner so that a torque is introduced by means of a shaft connected with the primary part 2 into the area of the elastic coupling 1. In this way, the primary part 2 is rotated correspondingly. This torque is then transferred to the secondary part 3 by means of the spring elements 4. Due to the elasticity of the spring elements 4, in this context peaks are attenuated in the transferred torque in the actually known manner, for example, so that a very uniform torque is applied in the area of the secondary part 3.

The spring element 4 in the representation of FIG. 1 is made up from several support plates 5 of which merely some are provided with a reference symbol, and elastic spring bodies 6 arranged between, which are from rubber or a suitable elastic polymer or suchlike, for example. This structural design can be seen more clearly once again in the representation of FIG. 2. For this purpose, in FIG. 2 merely two of the elastic spring bodies 6 are shown, which are alternately stacked with support plates 5 to the spring element 4 and/or the part of the spring element 4 shown here. In the side elevation in FIG. 2a), a central axis A of the spring element 4 and therefore finally also of the support plates 5 and the elastic spring bodies 6, can moreover be identified. FIG. 2b) now represents a horizontal projection of this structural design. In this context it can be seen that the spring element 4 in the embodiment represented here comprises a rectangular form with the height

H and the width B. In the FIGS. 1 and 2 it can be seen that the central axis A is realized as a straight axis. The structural design of the spring element 4 is therefore designed such that the elastic spring bodies 6 and the support plates 5 respectively comprise parallel surfaces, or those which are essentially developed perpendicular to the central axis A. This structural design then requires a corresponding adaptation of the contact surfaces of the elastic spring body 4 to the primary part 2 and the secondary part 3. The contact surfaces there do not extend radially when viewed from the elastic coupling 1, but reciprocally parallel, so that the essentially rectangular spring element 4 can be accommodated. An alternative which is likewise known from the prior art provides, however, that the elastic spring bodies 6 and/or the support plates 5 are developed wedge-shaped, so that contact surfaces extending radially can be realized. This has the disadvantage, however, that force components are developed in the radial direction to the outside in the area of the spring element 4, which produce additional loading on the spring element 4. In the structural design represented here with parallel, essentially square-shaped spring elements 4, this disadvantage can be avoided. This however does not only apply to the square spring elements 4 represented in FIGS. 1 and 2, but naturally also for corresponding spring elements with an oval or round outer contour perpendicular to central axis A, for example.

As can be seen in the representation of FIGS. 1 and 2, the spring elements 4 are respectively bordered toward the outside by terminal support plates 5. The support plates 5 consist typically of a metallic material. The spring element 4 itself can then be developed as a single unit, in which the support plates 5 and elastic spring bodies 6 are firmly connected to each other by means of suitable methods. Apart from sundry adhesive processes, this can be performed by vulcanizing if elastic spring bodies 6 from rubber are used, in particular the connection of the support plates 5 with the elastic spring bodies 6.

It can particularly be seen in the enlarged representation of FIG. 2 that the elastic spring bodies 6 have a groove 7 which on its end face is developed circumferentially around the elastic spring body 6. For the further explanation of the invention represented here, in this context the course of a contour of this groove 7 is of decisive importance. The course of the contour of this groove 7 is subsequently appropriately described respectively in a plane in which the central axis A of the elastic spring body 6 and thus of the spring element 4 extends. Because the groove 7 is preferably developed with an identical contour circumferentially around the elastic spring body 6, the following is therefore applicable for any plane with the central axis A.

The representations of FIGS. 3 and 4 show corresponding sections from one of the elastic spring bodies 6 with two support plates 5 that are arranged adjacently hereto, in which the contour of the groove 7 can be seen in detail once more.

The structural design represented in FIG. 3 is the previously normal structural design of the prior art. The elastic spring body 6, which is developed from rubber, for example, is vulcanized onto the support plates 5 and comprises the groove 7. The connecting surface from the support plate 5 to the elastic spring body 6 in this context is merely as thick as necessary for the vulcanizing. The groove 7 has a contour which is designed as a simple arc. In the representation of FIG. 3b) it can be seen that this structural design pursuant to the prior art is now in the biased state as indicated by the arrows F. Moreover it can be seen in the representation of FIG. 3b) with the elastic spring body 6 pursuant to the prior art that the contour of the groove 7 in the biased state is essentially developed like a rounded W. The contour thus has two inflection points if these are viewed as a curve. In this way this results in a very strong notch effect on the end face of the elastic spring body 6 pursuant to the prior art. To counteract this, the elastic spring body 6 must be developed accordingly big and voluminous, which impacts the physical size of the elastic coupling 1 negatively, however.

In the representation of FIG. 4, the structural design of the contour of the groove 7 as taught by the invention can now be identified. FIG. 4a) here too shows a structural design in the unbiased state, while in FIG. 4b) the biased state is shown as indicated again by the arrows F. The contour of the groove 7 in the representation of FIG. 4 is now developed so that this also does not have an inflection point in the biased state. In the representation of FIG. 4 it can moreover be seen that the contour of the groove 7 does not attach directly in the area of the connection between the elastic spring body 6 and the support plates 5, but that the contour itself merely accounts for a width of 85%-95%, preferably 93.5%, of the entire elastic spring body 6. This structural design with corresponding edge thicknesses which extend essentially parallel to the central axis A of the elastic spring body 6 makes it possible to let the contour of the groove 7 begin defined in the area of the elastic spring body 6 itself, so that in the area in which the groove discontinues, only the material of the elastic spring body 6 is involved and in the event of any forces occurring in the radial direction, the connection between the elastic spring body 6 and the support plate 5 will not be subjected to shear by such forces.

To achieve such contour of groove 7, which in the biased state, as it is indicated in FIG. 4b), for example, does not have an inflection point, the contour in the unbiased state must essentially be developed such that this is axisymmetrical to a centerline L which in a plane is developed perpendicular to central axis A of the elastic spring body 6. This centerline L is correspondingly indicated in FIG. 5. The contour of the groove 7 in this context must be developed in each half starting from a gradient of zero in direction of the support plate 5 with an increasing gradient, in particular with a continuously increasing gradient. In principle, such form could also be accomplished by a parabola, for example.

The inventors have now found that a particularly favorable and advantageous structural design of the course of the contour of the groove 7 can be accomplished if in the unbiased state of the elastic spring body 6 a contour selected which demonstrates a very low susceptibility against notch effect. Such a contour is shown as an example in the right half of FIG. 5. In this context, the contour is defined by a set of several straights GH, G1, . . . Gn in the direction of the central axis A of the elastic spring body 6. The contour itself then roughly follows this set of straights with a continuous curve. In the right half in the representation of FIG. 5, such structural design can be identified and will be explained by means of an example. The structure begins in the area of the centerline L with a gradient of zero of the contour of the groove 7. The curve then adapts to a first straight G1, which results in a first angle W1 In this context, this angle W1 corresponds ideally to the angle bisector between the centerline L and an applied auxiliary straight GH which corresponds to the gradient in the tangency point of the contour. Because the gradient, as previously mentioned, must be zero, the auxiliary straight GH is arranged at a right angle to the centerline L. The angle W1 of the straight G1 relative to this auxiliary straight GH will also be approximately 45°. In this context, angles in the range of between 40 and 50° for example are naturally also conceivable. After approximately half of the width or a width of approximately 40-60% of the contour (without the edge thicknesses) has been reached in the projection onto a perpendicular to the centerline L, a second straight G2 starts on the first straight G1. The angle W2 of this new straight G2 relative to the first straight GI now amounts to 40-60% of the angle W1 between the first straight G1 and the auxiliary straight GH. Again, after half of the remaining residual width of the contour in the projection has been crossed, a further straight G3 starts on the straight G2. In this context, the angle W3 between the straight G2 and the straight G3 is again 40-60% of the angle W-2 between the two antecedent straights G1 and G2. Preferably, an angle bisector is to also start here again, so that the angle W3 in particular is 50% of the angle W-2. This structure continues accordingly, wherein in the representation selected here also the straights G4 and G5 are shown. The contour of the groove 7 then adapts to this set of straights from G1 to G5 correspondingly. In principle, almost any number from 1 to n straights is conceivable.

This structure of the elastic spring body 6 which is optimal with respect to the notch effect in the unbiased state then makes it possible, as already mentioned several times, that a very high stability of the elastic spring body 6 can be accomplished also in the biased state. This in particular results in that the elastic spring body 6 can be structured so that its width B represented in FIG. 2 can be reduced by a value of up to one third relative to a structure pursuant to the prior art, without that the mechanical properties of a spring element 4 provided with such elastic spring elements 6 will be impacted negatively. Thus, a very much narrower design of the elastic coupling 1 in the axial direction is possible.

In the left half of FIG. 5, now an alternative structure for one half of the contour of the groove 7 is represented. Based upon a circular arc K, the contour transitions continuously into a tangent function denoted with T at a point P. A comparable structure with a detailed description of the necessary mathematical functions is known from the application with the German file reference DE 10 2008 045 318.8 of the applicant. This structural design can be transferred analagously to the contour described here, so that the structural design will not be discussed in further detail here. This structural design also has a small notch effect, since it follows the structural design which is described on the right side which is comparatively complex to build. The structure on the left half of FIG. 5 can thus be used as an alternative, if it can be realized more simply in terms of aspects regarding technical manufacturing, without causing appreciable disadvantages regarding the functionality of the elastic spring bodies 6.

In this context, the contour of the groove 7 can in principle be designed as the type illustrated here only in sections of the elastic spring body 6 that are subjected to heavy loads. However, particularly preferred is a structural design in which the contour is developed circumferentially around the entire end-faces of each of the elastic spring bodies 6 of the spring elements 4 in the manner presented.

1-13. (canceled)

14. An elastic coupling with
a primary part;
a secondary part;
several spring elements arranged between the primary part and the secondary part, distributed around the circumference;
at least one elastic spring body in each of the spring elements, which is arranged between two support plates, wherein
the elastic spring body comprises a circumferential groove in the area of its end faces, characterized in that
the course of a contour of the groove in a plane in which the central axis of the elastic spring body extends does not have an inflection point in the biased state of the elastic spring body.

15. The elastic coupling according to claim 14, characterized in that
the contour of the groove in the unbiased state is developed axisymmetrical to a centerline in the plane in which the central axis of the elastic spring body extends, wherein
each of the halves of the contour is developed so, based upon no gradient in the area of the centerline, it extends with an increasing gradient.

16. The elastic coupling according to claim 15, characterized in that the gradient rises continuously.

17. The elastic coupling according to claim 14, characterized in that
the contour of the groove in the unbiased state is developed axisymmetrical to a centerline in the plane in which the central axis of the elastic spring body extends, wherein each of the halves of the contour is developed so that
the contour of the groove is defined from multiple straights in direction of the central axis and the adjacent support plate, wherein
a first straight starting from the centerline in the first angle of 40-50°, in particular 45°, extends perpendicular to an auxiliary straight arranged perpendicular to the centerline; and
any further straight on the antecedent straight starts in a point in which a projection of the antecedent straight perpendicular to the centerline reaches 40-60%, in particular 50%, of the remaining residual width of the half of the contour, wherein
the angle between the straight and the previous straight amounts to 40-60%, in particular 50%, of the angle between the antecedent (auxiliary) straight.

18. The elastic coupling according to claim 15, characterized in that
the contour of the groove in the unbiased state is developed axisymmetrical to a centerline in the plane in which the central axis of the elastic spring body extends, wherein each of the halves of the contour is developed so that
the contour of the groove is defined from multiple straights in direction of the central axis and the adjacent support plate, wherein
a first straight starting from the centerline in the first angle of 40-50°, in particular 45°, extends perpendicular to an auxiliary straight arranged perpendicular to the centerline; and
any further straight on the antecedent straight starts in a point in which a projection of the antecedent straight perpendicular to the centerline reaches 40-60%, in particular 50%, of the remaining residual width of the half of the contour, wherein
the angle between the straight and the previous straight amounts to 40-60%, in particular 50%, of the angle between the antecedent (auxiliary) straight.

19. The elastic coupling according to claim 16, characterized in that
the contour of the groove in the unbiased state is developed axisymmetrical to a centerline in the plane in which the central axis of the elastic spring body extends, wherein each of the halves of the contour is developed so that
the contour of the groove is defined from multiple straights in direction of the central axis and the adjacent support plate, wherein
a first straight starting from the centerline in the first angle of 40-50°, in particular 45°, extends perpendicular to an auxiliary straight arranged perpendicular to the centerline; and
any further straight on the antecedent straight starts in a point in which a projection of the antecedent straight perpendicular to the centerline reaches 40-60%, in particular 50%, of the remaining residual width of the half of the contour, wherein
the angle between the straight and the previous straight amounts to 40-60%, in particular 50%, of the angle between the antecedent (auxiliary) straight.

20. The elastic coupling according to claim 14, characterized in that
the contour of the groove in the unbiased state is developed axisymmetrical to a centerline in the plane in which the central axis of the elastic spring body extends, wherein each of the halves of the contour is developed so that
the contour of the groove is developed by a circle segment and the part of a tangent function, wherein
the part of the circle segment extends starting from the centerline up to a point, in that it transitions continuously into the tangent function.

21. The elastic coupling according to claim 15, characterized in that
the contour of the groove in the unbiased state is developed axisymmetrical to a centerline in the plane in which the central axis of the elastic spring body extends, wherein each of the halves of the contour is developed so that
the contour of the groove is developed by a circle segment and the part of a tangent function, wherein
the part of the circle segment extends starting from the centerline up to a point, in that it transitions continuously into the tangent function.

22. The elastic coupling according to claim 16, characterized in that
the contour of the groove in the unbiased state is developed axisymmetrical to a centerline in the plane in which the central axis of the elastic spring body extends, wherein each of the halves of the contour is developed so that
the contour of the groove is developed by a circle segment and the part of a tangent function, wherein
the part of the circle segment extends starting from the centerline up to a point, in that it transitions continuously into the tangent function.

23. The elastic coupling according to claim 14, characterized in that the course of the contour of the groove is essentially developed identical in each of the planes with the central axis.

24. The elastic coupling according to claim 15, characterized in that the course of the contour of the groove is essentially developed identical in each of the planes with the central axis.

25. The elastic coupling according to claim 16, characterized in that the course of the contour of the groove is essentially developed identical in each of the planes with the central axis.

26. The elastic coupling according to claim 17, characterized in that the course of the contour of the groove is essentially developed identical in each of the planes with the central axis.

27. The elastic coupling according to claim 14, characterized in that the width of the contour occupies 85%-95%, preferably 93.5%, of the thickness of the elastic spring body, wherein on both sides of the contour, parts of the elastic spring body remain between the contour and the support plates, the outer contour of which essentially extends perpendicular to the center line.

28. The elastic coupling according to claim 14, characterized in that the surfaces of the elastic spring body and the support plates facing each other are essentially developed perpendicular to the central axis of the spring element.

29. The elastic coupling according to claim 14, characterized in that the surfaces of the elastic spring bodies and the support plates developed perpendicular to the central axis are developed essentially reciprocally parallel in each of the elastic spring bodies and the support plates.

30. The elastic coupling according to claim 14, characterized in that each of the spring elements comprises several elastic spring bodies and support plates alternately stacked on top of each other.

31. The elastic coupling according to claim 14, characterized in that the elastic spring bodies are developed from rubber and the support plates from metal, wherein the elastic spring bodies and the support plates within a spring element are connected together by vulcanizing.

32. The elastic coupling according to claim 14, characterized in that each of the elastic spring bodies comprises a rectangular cross-section in a plane perpendicular to its central axis.

33. The elastic coupling according to claim 14, characterized in that the spring elements are essentially developed square.
